(19) United States
(12) Patent Application Publication
(10) Pub. No.: US 2026/0279363 A1
(43) Pub. Date: Sep. 17, 2026

(54) Optimized processing for reducing channels of a stereophonic audio signal

(71) Applicant: ORANGE, Issy-les-Moulineaux (FR)

(72) Inventors: Alexandre GUERIN, CHATILLON (FR); Arnaud LEFORT, CHATILLON (FR); Stéphane RAGOT, CHATILLON (FR)

(21) Appl. No.: 19/473,276

(22) PCT Filed: Apr. 10, 2024
(86) PCT No.: PCT/EP2024/059644

§ 371 Date: Oct. 7, 2025

(30) Foreign Application Priority Data
Apr. 13, 2023 (FR) FR2303719
Apr. 27, 2023 (FR) FR2304288
May 23, 2023 (FR) FR2305109

(51) Int. Cl. G10L 19/008

(52) U.S. Cl. CPC G10L 19/008

(57) ABSTRACT

A method and downmixing device for downmixing a stereophonic signal in order to obtain a monophonic signal. The method includes, for a stereophonic-signal frame, selection between: a first downmixing mode having filtering with rephasing in each of the channels of the stereophonic signal by an angle defined by half the phase difference determined between the two channels of the stereophonic signal; and a second downmixing mode having filtering with rephasing in a single one of the channels of the stereophonic signal by an angle defined by the phase difference determined between the two channels of the stereophonic signal. The selection of the first downmixing mode or of the second downmixing mode is dependent on the value of a phase indicator determined per frame.

### TECHNICAL FIELD

The present invention relates to the general field of processing audio signals. The invention relates, in particular, to downmixing of a multichannel audio signal.

Downmixing of a stereophonic signal to a monophonic signal is of particular interest.

This type of processing is generally applicable in the field of audio technologies, and more specifically in the field of audio coding, whether it is in the coding or decoding step.

### PRIOR ART

Downmixing consists in deducing, on the basis of a combination of the N channels of a multichannel signal x, a signal y consisting of a smaller number M of channels. In practice, this consists in defining a function ƒ(.) such that:

$$y ( n ) = [ \begin{matrix}y ( n ) \\ ⋮ \\ {y}_{M} ( n )\end{matrix} ] = f ( x ( n ) ) = f ( [ \begin{matrix}{x}_{1} ( n ) \\ ⋮ \\ {x}_{M} ( n )\end{matrix} ] ) , with M < N$$

In this invention, the particular case M=1 and N=2 is of interest; reference will, then, be made to mono downmixing. In the case N=2, reference is made to stereo content or stereo signal, where channel 1 (x₁) is referenced as the left channel or channel L, and channel 2 (x₂) as the right channel or channel R. In the case of the signal y obtained after downmixing, reference is made to a monophonic or mono signal, which will be noted M below.

These stereo signals may result from capture by a pair of stereo microphones. There are a certain number of pairs of microphones allowing this type of content to be created.

Among the most popular, mention may be made of the XY pair composed of 2 cardioid microphones exhibiting a difference in orientation angle of between 90° and 135°. The MS (mid-side) pair is another very widespread pair composed of a microphone of cardioid directivity and of a second microphone, referred to as a “figure of 8” microphone, oriented at 90°. By combining these 2 mics (sum/difference), the left and right stereo content channels may be created. These pairs are referred to as coincident pairs, that is to say that the microphone capsules do not exhibit a delay between them, the spatialization being perceived by the difference in sound intensity between the left channel and right channel.

Another category of pairs referred to as phase stereophony pairs consists in using microphones which are distant from one another, thus creating a phase difference between the channels for the sources located closer to one of the mics. The most known is the AB pair, which utilizes 2 omnidirectional microphones spaced apart by a few centimeters to several meters. Another very widespread pair is the ORTF pair, which utilizes both a phase difference through a spacing of 17 cm of the microphones and an amplitude difference through cardioid directivities (the microphones exhibit an angle of around 90°). The binaural pair consists in placing omnidirectional microphones in the ears of an artificial head: this type of device makes it possible to create content natively, which may be listened to through the headset.

The simplest method for creating a signal reduced by downmixing is that referred to as passive downmixing. It consists in taking an average of the left channel and right channel of the stereo signal such that:

$$m ( t ) = \frac{{x}_{1} ( t ) + {x}_{2} ( t )}{2}$$

or, in the frequency domain:

$$M ( k , f ) = \frac{{X}_{1} ( k , f ) + {X}_{2} ( k , f )}{2}$$

where Xᵢ(k,f),i=1,2 is the fast Fourier transform xᵢ(t) (FFT), f being the index of the frequency and k the index of the frame:

$${X}_{i} ( k , f ) = {\sum }_{l = 0}^{N - 1} w ( l ) \cdot {\check{x}}_{i} ( k , l ) {e}^{- \frac{j 2 π l f}{N}} , for any f ∈ \{ 0 , … , N - 1 \}$$

where k is the index of the frame, of size L, and N is the size of the FFT, and w(.) is a sine or Hann or other apodization window, adapted to the size of the frame. x̌ᵢ(.) can be the signal xᵢ(t) itself or a 0-padded version thereof: for example, in the case where the size of the frame L is smaller than the size of the FFT N, x̌ᵢ(k,.) may be:

$${\check{x}}_{i} ( k , l ) = [ 0 , … , 0 , w ( l ) {x}_{i} ( k * L + l ) ] , 0 \leq l < L$$

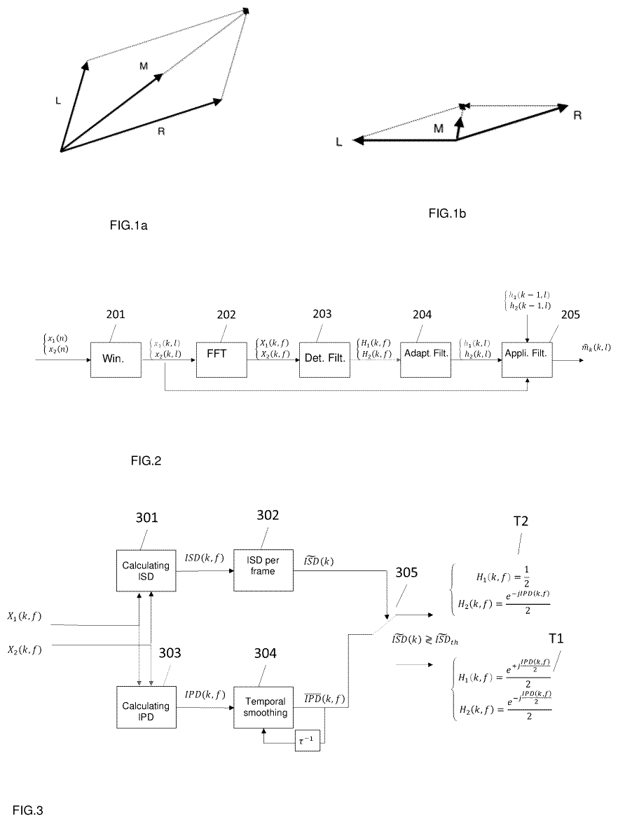

This very simple method operates very well in situations in which the right channel and left channel are in phase. However, in situations in which the microphones are not coincident and exhibit phase differences, such mixing generates comb filtering, which is manifested by coloration of the original signal. This is due to the fact that, depending on the spacing of the microphones, on the position of the source with respect to the pair of microphones and on the frequency, the left channel and right channel of the same source may be either in phase, as depicted in FIG. 1a, or in phase opposition as depicted in FIG. 1b. Thus, when downmixing, the left signal and right signal will either add (constructive interference) or cancel out (destructive interference), thus creating variations in level and effects of coloration of the reduced signal m(t). The coloration comes from the effect of comb filtering: the effects of constructive and destructive interference are manifested in different frequency bands, thus modifying the balance and thus the tone of the signal resulting from the downmixing with respect to the original.

In order to correct this defect of intensity level according to frequencies, the downmixing of the e−AAC+codec implements level correction γ(f) which ensures that the energy level of the reduced signal, in each frequency band, remains comparable to the original one:

$$M ( f ) = γ ( f ) \cdot \frac{{X}_{1} ( f ) + {X}_{2} ( f )}{2} ,$$

$$γ ( f ) = \sqrt{\frac{{\vert {X}_{1} ( f ) \vert}^{2} + {\vert {X}_{2} ( f ) \vert}^{2}}{0.5 {\vert {X}_{1} ( f ) + {X}_{2} ( f ) \vert}^{2}}}$$

This approach makes it possible to compensate, to a certain extent, for the drop in intensity of the downmixing. However, this compensation leads to over-amplification when the signals are close to phase opposition: thus, in practice, the correction factor γ(f) is capped (a factor 2 seems to be an upper limit).

With the same approach, FIG. 7 describes a method for reducing stereo channels to mono which is integrated into the public candidate IVAS codec which is available at the address:
https://forge.3gpp.org/rep/ivas-codec-pc/ivas-codec/-/tree/main

The signal x(m) with 2 input channels is deinterleaved (block 701) to find both the left channel and the right channel. Next, a frequency analysis with windowing and Fourier transform (blocks 702 and 703) is performed in order to obtain the spectra of the 2 channels, and the intercorrelation on the basis of the phase spectra is estimated (block 704) before determining the time difference between the channels (here labeled ITD even though it is formally an ICTD between 2 channels) by searching for a peak (block 705); the block 705 also provides the correlation level R* corresponding to the ITD.

The downmixing factors are then determined as follows (block 706):

```
if (itd != 0):
  g = − 0.5 * R* + 0.5 if itd>0
    0.5 * R* + 0.5 if itd<0
else
  g = 0.5
```

The 2 channels are combined into a mono signal in the block 706 with this gain g (with smoothing of the value of the gain applied sample by sample at the start of each frame). Next, the energies of the left channel and right channel and of the mono signal are determined (blocks 708, 709, 710). The left channel and right channel are separately reinjected (added), in the blocks 713 and 713, into the mono signal resulting from the block 706 depending on energy compensation determined in the block 711 with respective scale factors defined in the blocks 712 and 713.

These methods, in addition to the coloration of the signal resulting from the downmixing, linked to the imperfectly corrected comb filtering, suffer from surplus reverberation linked to the summation of signals that are out of phase. Specifically, compensating for a delay which is identical for all the frequencies is not realistic, this delay being linked to the various sources composing the content. In practice, this leads, besides additional coloration, to a potential loss of intelligibility of the sources, which defect level compensation cannot correct.

Other downmixing approaches seek to avoid the aforementioned defects. The principle of these methods is to rephase the left signal and right signal before they are summed. In the document entitled “A stereo to mono downmixing scheme for MPEG-4 parametric stereo encoder” by Samsudin, E. Kurniawati, N. Boon Poh, F. Sattar, S. George, in Proc. ICASSP, 2006, a method which consists in applying, in the frequency domain, a phase shift φ to one of the channels, generally the right one, in order to rephase it with the left channel, is proposed, such that:

$$M ( f ) = \frac{{X}_{1} ( f ) + {X}_{2} ( f ) \cdot {e}^{- j φ ( f )}}{2}$$

The ideal phase shift is given by what is called the IPD (inter-channel phase difference):

$$IPD ( f ) = ∠ ( {X}_{1} ( f ) \cdot {X}_{2}^{*} ( f ) )$$

where X* is the conjugate of X and L indicates the phase of the complex operand.

It is calculated in the frequency domain: this makes it possible to rephase the spectral components of various sources, a source with its own IPD being able to be preponderant in a frequency band f, while another source with a different IPD may be preponderant in another band f′.

In the case of the MPEG4 codec described in the Samsudin document cited above, the IPD applied is that estimated by averaging over a Bark band and not the IPD calculated for each frequency band, the latter proving to be particularly noisy and variable from one frame to the next.

In the published patent application WO2017103418, a downmixing method which mixes the method proposed by Samsudin and passive downmixing is proposed. Notably, it proposes an ISD (inter-spectral distance) indicator which makes it possible to choose, frequency band by frequency band, which is the most suitable method for rephasing the signals:

$$ISD ( f ) = \frac{\vert {X}_{1} ( f ) - {X}_{2} ( f ) \vert}{\vert {X}_{1} ( f ) + {X}_{2} ( f ) \vert}$$

This indicator makes it possible to measure whether the signals are in phase (ISD<1), that is to say with a phase difference or IPD in the interval

$$[ - \frac{π}{2} , \frac{π}{2} ] ,$$

or rather in phase opposition (ISD>1), i.e. with an IPD in the interval

$$[ \frac{π}{2} , \frac{3 π}{2} ] .$$

When they are in phase opposition, a high ISD value is synonymous with a comparable level between the left channel and the right channel and rephasing is important to avoid the effects of coloration and of dropout. By contrast, an ISD value which is close to 1 is representative of one channel which is preponderant with respect to the other; in this latter case, rephasing is unimportant, since downmixing is almost equal to the preponderant signal. It is, however, important to avoid modifying the phase of the right channel if the latter is preponderant. Thus, in this patent application, a following downmixing selection mechanism is proposed:

$$\{ \begin{matrix}M ( f ) = \frac{{X}_{1} ( f ) + {X}_{2} ( f ) \cdot {e}^{- jIPD ( f )}}{2} , & if ISD ( f ) > 1.3 \\ M ( f ) = \frac{{X}_{1} ( f ) + {X}_{2} ( f )}{2} , & if ISD ( f ) < 1.3\end{matrix}$$

The passive downmixing proposed in the aforementioned patent application sometimes introduces increased reverberation when ISD is low.

Moreover, the method proposed in this patent application requires the application of filtering in the spectral domain, the reduced signal being reconstructed on the basis of the inverse short-time Fourier transform (STFT) of the signal M(f, k). This type of filtering generates a circular convolution which creates audible artifacts: echo, pre-echo and static. In order to mask these artifacts, an implementation with frame overlap associated with suitable windowing (analysis and/or synthesis window) guaranteeing reconstruction of the filtered signal may be used. Generally, this overlap is not compatible with the operation of the audio coders which work with adjacent frames, i.e. without overlap (N=L); in addition, this type of reconstruction leads to a delay, generally of half a frame, which is the conventional overlap, which is not acceptable for a coder which has strong constraints in terms of latency.

Another overlap-add (OLA) implementation is also possible: this method requires a step of 0-padding the signals and the filters in order to avoid circular convolution. However, tests show that with such filters, the phase of which varies very rapidly from one frame to the next, an OLA approach does not make it possible to mask artifacts completely at the transition of certain frames, the artifacts then remaining audible.

### DISCLOSURE OF THE INVENTION

The invention aims to improve the prior art.

To this end, the invention relates to a method for downmixing a stereophonic signal in order to obtain a monophonic signal, comprising, for a stereophonic-signal frame, selection between:
a first downmixing mode comprising filtering with rephasing in each of the channels of the stereophonic signal by an angle defined by half the phase difference determined between the two channels of the stereophonic signal, and
a second downmixing mode comprising filtering with rephasing in a single one of the channels of the stereophonic signal by an angle defined by the phase difference determined between the two channels of the stereophonic signal, selection of the first downmixing mode or of the second downmixing mode being dependent on the value of a phase indicator determined per frame.

Thus, by shifting the two channels of the stereo signal according to the first downmixing mode, the addition of reverberation is limited or even prevented. Furthermore, the shift by half the determined phase difference between the two channels of the stereo signal greatly limits the coloration of the spectra of the modified left and right signals compared with the Samsudin method cited above, which modifies the single right channel by the phase difference.

Selection between the two downmixing modes makes it possible to adapt the downmixing to the channels of the stereo signal.

Selection of the first downmixing mode is advantageous in situations where the intensity of the right channel is preponderant (phase indicator, ISD, close to 1) and participates predominantly in the downmixing: it undergoes a reduced spectral modification, which in practice is almost inaudible.

The invention thus improves on the prior art by making provision for selection of a downmixing method suitable for application in the case where the signals are in phase or of unbalanced volume.

In one embodiment, the method further comprises a step of determining a phase indicator for each frequency f, which indicator is representative of a measurement of the degree of phase opposition between the frequency components of the channels of the stereo signal, then a phase indicator per frame of the stereophonic signal, which indicator is calculated based on the percentage of frequencies for which the phase indicator per frequency exceeds a first threshold.

In one embodiment, if the phase indicator per frame is less than a second threshold the first downmixing mode is applied to the current frame, and if the phase indicator per frame is greater than the second threshold the second downmixing mode is applied to the current frame.

Thus, this decision per frame makes it possible to avoid substantial phase shifts between frequencies and other audible artifacts which may appear when the decision varies from one frequency to the next, as in the prior-art methods.

In another embodiment, an indicator of the time difference between the stereo channels is determined per frame of the stereo signal, a third downmixing operation being implemented in the case where the indicator is above a threshold.

Thus, another criterion is applied to select, in this embodiment, another downmixing method, called the third operation.

In one particular embodiment, taking into account the indicator of the time difference between the stereo channels, which is determined per frame of the stereo signal, in the case where this indicator is less than a threshold, the phase indicator per frame is compared with the second threshold in order to determine whether to apply a first or a second downmixing operation to this frame.

The time difference indicator is then compared upstream of the comparison of the phase indicator with another threshold. These various comparisons make it possible to optimally adapt the downmixing operation to the characteristics of the stereo signal.

In one embodiment, the determined phase difference between the two channels of the stereo signal is smoothed over time via a forgetting factor.

Specifically, the phase difference can vary rapidly over time. Thus, the filters used for the various downmixing operations may vary very rapidly from one frame to the next, which generates discontinuities which are sometimes audible during the transition from one frame to the next.

Smoothing the phase difference therefore makes it possible to limit this effect.

In one embodiment, the downmixing operation corresponds to filtering of the channels with filters, the method comprising a preliminary phase of defining the filters before application to the stereo signal, by means of at least one truncating and windowing operation.

This adaptation of the filters makes it possible to avoid a circular convolution and a latency that may arise in the methods of the prior art.

This preliminary phase of defining the filters comprises, in one embodiment, the following adapting steps:
obtaining impulse responses of the filters corresponding to the downmixing operation;
truncating part of the impulse responses;
weighting the remaining part by applying a weighting window;
normalizing the impulse responses resulting from the windowing to obtain the adapted filters which are to be applied to a stereo signal frame.

Advantageously, from one frame to the next the operation of downmixing with adapted filters is applied with a cross-fade step taking into account the impulse responses of the filters used for the frame preceding the current frame.

This cross-fading transition makes it possible to avoid audible artifacts when the filters are very different between two successive frames, for example when a new source appears.

The invention targets a downmixing device comprising a processing circuit for implementing the steps of the downmixing method as described above.

The invention relates to a computer program comprising instructions for implementing the downmixing method as described above when it is executed by a processor.

Lastly, the invention relates to a storage medium, which can be read by a processor, storing a computer program comprising instructions for executing the downmixing method described above.

### BRIEF DESCRIPTION OF THE DRAWINGS

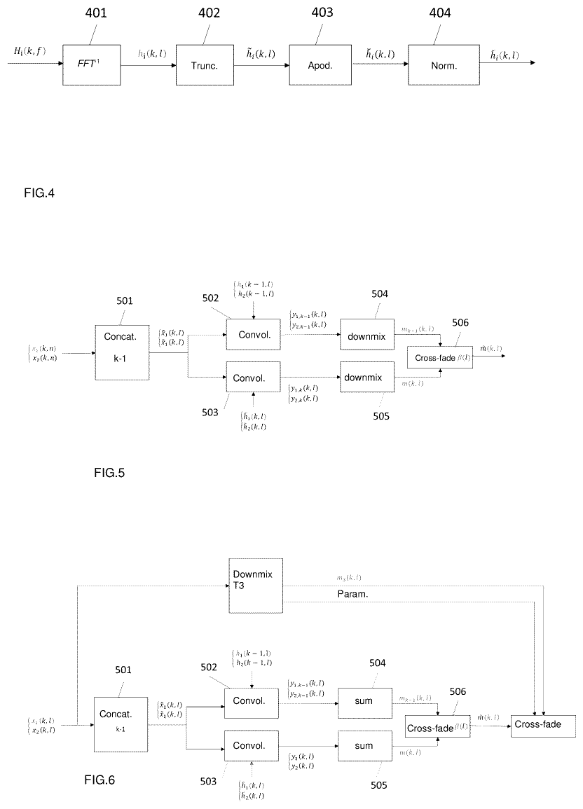

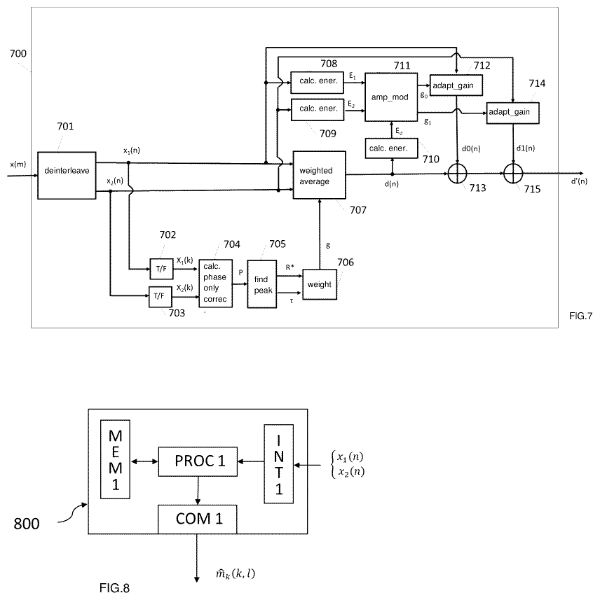

Other features and advantages of the invention will become more clearly apparent upon reading the following description of particular embodiments, which are given by way of mere illustrative and non-limiting examples, and the appended drawings, among which:

[FIG. 1a] illustrates channels of a stereophonic signal, in phase as described above;

[FIG. 1b] illustrates channels of a stereophonic signal, in phase opposition as described above;

[FIG. 2] illustrates, in the form of a block diagram, a downmixing sequence in one embodiment of the invention;

[FIG. 3] illustrates one embodiment of a filter calculation for the downmixing, as well as a selection of a downmixing operation;

[FIG. 4] illustrates one embodiment of a phase of adapting a downmixing filter;

[FIG. 5] illustrates one embodiment of a transition of the application of the downmixing during a transition between two frames of stereo signal;

[FIG. 6] illustrates another embodiment of a filter calculation for the downmixing, as well as a selection of a downmixing operation;

[FIG. 7] illustrates an existing downmixing method described above;

[FIG. 8] illustrates one example of a structural embodiment of a downmixing device according to one embodiment of the invention.

### DESCRIPTION OF THE EMBODIMENTS

FIG. 2 shows one example of a sequence for processing a stereophonic audio signal, the processing operation comprising a downmixing operation.

At the input of this processing sequence, a stereophonic signal x, composed of two channels (x₁(n) and x₂(n)), also called the right channel and left channel, is, in a first stage, divided, in 201, into frames of L samples (x₁(k, l) and x₂(k, l), k being the index of the frame and n the index of the sample). The block 202 applies an FFT (for fast Fourier transform), in order to obtain signals in the frequency domain (X₁(k, f) and X₂(k, f), f being the index of the frequency). In 203, the downmixing filter to be applied to a signal frame is then selected and determined. This step will be described with reference to FIG. 3. The filter thus determined is conditioned (or adapted) in 204 in order to make it causal and optimize it in order to reduce processing complexity. This adaptation phase is described with reference to FIG. 4.

Once the filter has been determined and adapted for the current frame, it is applied, in 205, to this current frame. In order to avoid audible artifacts which are due to a change of filters between two frames, a cross-fade is carried out by taking into account the filter of the previous frame

$$\{ \begin{matrix}{h}_{1} ( k - 1 , l ) \\ {h}_{2} ( k - 1 , l )\end{matrix} .$$

This step will be described with reference to FIG. 5.

FIG. 3 describes a detailed embodiment of the block 203 of FIG. 1. In this processing block, a first or a second downmixing operation to be applied to a current frame of the stereophonic signal is selected and determined.

A first downmixing method T1 is defined here by shifting the left channel and right channel of the stereophonic signal simultaneously by an angle defined by half the phase difference (IPD) determined between the two channels of the stereo signal. There is thus a downmixing signal, as follows:

$$M ( k , f ) = \frac{{X}_{1} ( k , f ) \cdot {e}^{+ j \frac{IPD ( k , f )}{2}} + {X}_{2} ( k , f ) \cdot {e}^{- j \frac{IPD ( k , f )}{2}}}{2}$$

This method makes it possible to avoid degradation of reverberation surplus type generated by conventional downmixing (average of the two signals) or of comb filtering type in the event of a temporal shift between the two channels.

This downmixing thus defined may be seen, in the frequency domain, as filtering according to the following equation:

$$M ( k , f ) = {H}_{1} ( k , f ) \cdot {X}_{1} ( k , f ) + {H}_{2} ( k , f ) \cdot {X}_{2} ( k , f )$$

with

$${H}_{1} ( k , f ) = \frac{{e}^{+ j \frac{IPD ( k , f )}{2}}}{2} and {H}_{2} ( k , f ) = \frac{{e}^{- j \frac{IPD ( k , f )}{2}}}{2} .$$

A second downmixing method T2 is, for example, defined as the one proposed in the Samsudin document cited above.

In this second method, then,

$${H}_{1} ( k , f ) = \frac{1}{2} and {H}_{2} ( k , f ) = \frac{{e}^{- jIPD ( k , f )}}{2} .$$

The channels of the stereo signal, in the frequency domain (X₁(k, f) and X₂(k, f)), are used, on the one hand, to calculate a phase indicator in 301, which is representative of a measure of the degree of phase opposition between the channels of the stereo signal and, on the other hand, the phase difference between the (IPD) channels in 303.

The phase indicator is, for example, defined by the ISD (inter-spectral distance) indicator as defined above.

In the embodiment described here, the ISD is determined by stereophonic signal frame in order for the decision to select a first downmix or a second to be able to be made frame by frame.

This decision by frame makes it possible to dispense with substantial phase shifts between frequencies and with other audible artifacts which may appear when the decision varies from one frequency to the next, as in the patent application cited above.

To apply a decision by frame, a decision criterion according to the ISD phase indicator is defined according to the following equation in 302:

$$\tilde{ISD} ( k ) = \frac{{card}_{f} \{ ISD ( k , f ) > 1.3 \}}{number of frequencies}$$

This criterion measures the percentage of frequencies the criterion of which is favorable to downmixing with rephasing, that is to say when ISD(k,f)>1.3. The decision is taken to apply the first downmix as defined above, with rephasing, when [symbol] exceeds a certain threshold [symbol] , which is set, for example, at 70%.

There is then, in 305, the following downmix selection decision between T1 and T2:

$$\{ \begin{matrix}\tilde{ISD} ( k ) < {\tilde{ISD}}_{th} : {H}_{1} ( k , f ) = \frac{{e}^{+ j \frac{IPD ( k , f )}{2}}}{2} , & {H}_{2} ( k , f ) = \frac{{e}^{- j \frac{IPD ( k , f )}{2}}}{2} \\ \tilde{ISD} ( k ) > {\tilde{ISD}}_{th} : {H}_{1} ( k , f ) = \frac{1}{2} , & {H}_{2} ( k , f ) = \frac{{e}^{- jIPD ( k , f )}}{2}\end{matrix}$$

In 303, the phase difference IPD is obtained between the two channels of the stereo signal by

$$IPD ( k , f ) = ∠ ( {X}_{1} ( k , f ) \cdot {X}_{2}^{f} ( k , f ) )$$

where < indicates the phase of the complex operand.

However, the frame decision may sometimes be insufficient since the IPD, as calculated according to the above formula, varies very rapidly over time. Also, the filters

Hᵢ(k,f), may vary very rapidly from one frame to the next, which generates discontinuities which are sometimes audible during the transition from one frame to the next. In order to limit this effect, a version of the IPD which is smoothed over time may be used to calculate the filters Hᵢ(k,f). One way of smoothing the IPD is to apply 1st-order IIR low-pass filtering, in 304, such that:

$$\overline{IPD} ( k , f ) = α ( f ) \overline{IPD} ( k , f ) + ( 1 - α ( f ) ) \overline{IPD} ( k , f )$$

The forgetting coefficient α(f) is chosen ad hoc. It may be advantageous to choose a high forgetting coefficient at lower frequencies, typically below 5 kHz, since this makes it possible to maintain phase coherence in the lower part of the spectrum from one frame to the next, the spectrum of the speech signals being stationary, notably in its lower part and the particular ear which is sensitive to the phase in this part of the spectrum. By contrast, it is advantageous to choose a low forgetting coefficient at higher frequencies: at higher frequencies, typically above 5 kHz, the phase continuity of the speech signals is less marked and the ear is less sensitive to phase discontinuities in this part of the spectrum.

A forgetting coefficient of the following form may be chosen:

$$α ( f ) = \{ \begin{matrix}{α}_{max} , & f < {f}_{low} \\ {α}_{min} , & f > {f}_{high} \\ {α}_{min} + \frac{f - {f}_{low}}{{f}_{high} - {f}_{low}} , & {f}_{low} < f < {F}_{high}\end{matrix}$$

The values αₘₐₓ, αₘᵢₙ, fₘₐₓ and fₘᵢₙ are determined experimentally. In the case of adjacent frames of length L=20 ms, the following set of following parameters may be chosen:

$${α}_{max} = 0.94 ,$$

$${α}_{min} = 0.86 ,$$

$${f}_{min} = 0 ,$$

$${f}_{max} = 5 kHz$$

FIG. 4 presently details the block 204 of FIG. 2. The filters Hᵢ(k,f) as, for example, defined in the downmixing methods T1 and T2 defined above are reconditioned or indeed adapted in order to avoid circular convolution.

In a first step, in 401, the impulse responses hᵢ(k,l) of the filters Hᵢ(k,f) are calculated, such that:

$${h}_{i} ( k , l ) = F F {T}^{- 1} \{ {H}_{i} ( k , f ) \} ,$$

$$i = 1 , 2$$

where the filters hᵢ(k,l) are of size N, dimension of the FFT.

The impulse responses thus defined are conventionally non-causal. One conventional technique for making them causal consists in rotating L/2 samples in order to center the response in L/2. The drawback is that the filter thus reconstructed then exhibits a latency of L/2. In order to avoid this latency, the choice is made to truncate the filter, in 402, retaining only a portion of the first half of the impulse response hᵢ(k,l) as follows:

$${\tilde{h}}_{i} ( k , l ) = {h}_{i} ( k , l ) ,$$

$$0 \leq l < P \leq N / 2$$

This filter exhibits the advantage of generally having a maximum (in absolute value) on its first sample, which guarantees zero latency. In terms of frequency response, it exhibits a phase which is almost equal to the optimal rephasing filter hᵢ(k,l).

The choice of P depends on various criteria: a value of P which is close to N/2 guarantees near-optimal rephasing, whereas a lower value makes it possible to limit the computational power which is necessary for filtering. A low value of P also results in smoothing the phase of the filter. This exhibits an advantage with filters defined by the processing operation T2 as defined above, where the phase varies very rapidly from one frequency to the next: these variations may result in a very high group delay which is perceptible to the human ear. A low value of P makes it possible to remove all or some of these artifacts.

The filter thus truncated \tilde{h}ᵢ(k,l), notably when P<N/2, or even P<<N/2, exhibits an impulse response tail which does not tend toward 0. This creates audible clicking discontinuities at the transition between 2 frames. Thus, in order to avoid these audible artifacts, \tilde{h}ᵢ(k,l) is weighted with a window w(l), in 403, such that:

$$\check{h} ( k , l ) = w ( l ) \cdot {\tilde{h}}_{i} ( k , l )$$

where w(l) is monotonically decreasing and the coefficients of which tend toward 0 when n tends toward P. This makes it possible to reduce the energy of the samples at the end of the filter and to avoid discontinuities during the transition between filters of consecutive frames.

This window may be a triangular half-window, or indeed a Hann half-window:

$$w ( l ) = \{ \begin{matrix}1 - l / P \\ cos ( l π / 2 P ) \\ ⋯\end{matrix}$$

On account of its truncation and the windowing, the filters \tilde{h}ᵢ(k,l) have a reduced energy with respect to that of the optimal filter hᵢ(k,n): the latter, as a pure phase-shifting filter, has a norm 1/2 by construction. Thus, the energy of the filter thus truncated and windowed may be normalized, in 404, such that:

$${\check{h}}_{i} ( k , l ) = \frac{{\check{h}}_{i} ( k , l )}{2 ‖ {\check{h}}_{i} ( k , l ) ‖}$$

where ∥x(.)∥ is the norm 2 of a vector. FIG. 5 presently describes in detail the block 205 of FIG. 1, where an OLS (overlap-save) implementation of the filtering is performed either in the time domain or in the frequency domain. The choice of domain will be made depending on complexity, which depends on the size of the filter relative to that of the frame to be processed.

An OLS implementation in the time domain is presented here, with adjacent frames of size L.

In a first stage, the current frame is concatenated, in 501, with the P-1 samples of the previous frame (save principle):

$${\tilde{x}}_{i} ( k , . ) = [ {x}_{i} ( k L - P + 2 ) , … , {x}_{i} ( k L - 1 ) , {x}_{i} ( k * L ) , … {x}_{i} ( ( k + 1 ) L - 1 ) ]$$

Each channel is filtered by its phase-shifting filter in 503:

$${y}_{i} ( k , l ) = {\sum }_{p = 0}^{P - 1} {\check{h}}_{i} ( k , p ) \cdot {\tilde{x}}_{i} ( k , l + P - p ) ,$$

$$0 \leq l < L$$

The mono downmix is then created by summing the two channels rephased in 505:

$$m ( k , l ) = {y}_{1} ( k , l ) + {y}_{2} ( k , l ) ,$$

$$0 \leq l < L$$

In practice, the filters may be very different between two successive frames, for example when a new source appears. In this case, the transition between m(k−1,l) and m(k,l) may become audible. To avoid these artifacts, a cross-fade step may be applied. In order to carry out this cross-fading, the filters \tilde{h}ᵢ(k−1,) are applied to the current frame over a number of samples X:

$${y}_{i , k - 1} ( k , l ) = {\sum }_{p = 0}^{P - 1} {\check{h}}_{i} ( k - 1 , p ) \cdot {\tilde{x}}_{i} ( k , l + P - p ) ,$$

$$0 \leq l < X$$

This is carried out by the block 502 of FIG. 5.

The number of samples which are necessary for the cross-fading will have to be determined experimentally, depending on the size of the filters, on the sampling frequency etc.

Next, the mono downmix m (k,l) is created in 504, on the basis of filters of the previous frame:

$${m}_{k - 1} ( k , l ) = {y}_{1 , k - 1} ( k , l ) + {y}_{2 , k - 1} ( k , l ) ,$$

$$0 \leq l < X$$

The signal resulting from the downmix \hat{m}(k,l) is created in 506, on the basis of a cross-fade according to the following equation:

$$\hat{m} ( k , l ) = \{ \begin{matrix}β ( l ) \cdot {m}_{k - 1} ( k , l ) + ( 1 - β ( l ) ) \cdot m ( k , l ) , & 0 \leq l < X \\ m ( k , l ) , & X \leq l < L\end{matrix}$$

where β(l) is a decreasing monotonic function, with β(0)=1 and β(X−1)=ε with ε being a value which is close to 0 or is zero. Typically, a Hann half-window may be chosen:

$$β ( l ) = cos ( \frac{l π}{2 X} ) ,$$

$$0 \leq l < X$$

It should be noted that, when integrated with other downmixing methods, as in FIG. 6, the methods cannot always be represented by a filtering operation. This is the case for the method T3 of FIG. 7 or any other method the gain of which depends on the instantaneous level of the signal.

FIG. 6 illustrates a downmixing device 600, within the meaning of the invention.

In this case, one solution is to calculate the downmixes of each method for the current frame k and to perform a transition from one downmix to the next by cross-fading. More specifically, in the case of a transition from a method T1 (or T2) to the method T3, the downmixing may be performed between the mono downmixes of the 2 methods, i.e. at the output of T1 (or T2), and the signal of the method T3. The downmixing may also be performed between the output of T1 (or T2) and the signal d(n). In this latter case, the energy compensation of the method T3 (adapt_gain) would be applied to all the methods continuously. The decision to switch from one method to another may be motivated by other criteria than the ISD, for example parameters already calculated by the method T3 (data Param. in FIG. 6) such as the ITD, by choosing to apply the method T3 when the ITD is very large for example, or any other criterion or combination of criteria.

FIG. 8 illustrates a downmixing device 800, within the meaning of the invention.

The device 800 comprises a processing circuit typically including:
a memory MEM1 for storing instruction data of a computer program within the meaning of the invention;
an interface INT1 for receiving a stereo audio signal x;
a processor PROC1 for receiving this signal and processing it by executing the computer program instructions which the memory MEM1 stores, with a view to carrying out downmixing; in particular, the processor being able to control the processing modules as described with reference to FIGS. 2 to 5; and
a communication interface COM 1 for transmitting the reduced signals, resulting from the downmixing, y, to another processing module, for example a coding or decoding module of an audio signal coder or decoder.

Of course, this FIG. 8 illustrates one example of a structural embodiment of a downmixing device within the meaning of the invention. FIGS. 2 to 7, commented on above, describe functional embodiments of this device in detail.

The applications of this type of downmixing are, for example, in audio coding, for example when the remote does not have the capabilities for rendering stereo sound on its terminal. In this case, it is not necessary to transport a stereo signal, and this makes it possible to save bandwidth. This type of method may operate during point-to-point conversations if one of the participants makes a stereo or binaural sound recording. This type of method may also be present during a multiparty call: the conference bridge spatializes the scene by creating a stereo scene, but not all the participants necessarily have stereo rendering capabilities. The scene should then be downmixed in mono for these participants.

The invention may also apply to audio decoding: in this case, it is the renderer (rendering module) of the user which will downmix the stereo content in order to adapt to the reduced capabilities of the user (a mere loudspeaker, for example).

1. A method for downmixing a stereophonic signal in order to obtain a monophonic signal, the method being performed by a downmixing device and comprising, for a stereophonic-signal frame, selecting between:
a first downmixing mode comprising filtering with rephasing in each channel of the stereophonic signal by an angle defined by half a phase difference determined between the channels of the stereophonic signal, and
a second downmixing mode comprising filtering with rephasing in a single one of the channels of the stereophonic signal by an angle defined by the phase difference determined between the channels of the stereophonic signal,
wherein the selecting between the first downmixing mode and the second downmixing mode is dependent on a value of a phase indicator determined per frame.

2. The method as claimed in claim 1, wherein the method further comprises determining a phase indicator for each frequency, wherein the phase indicator is representative of a measurement of a degree of phase opposition between frequency components of the channels of the stereophonic signal, then the phase indicator per frame of the stereophonic signal, which is calculated based on a percentage of frequencies for which the phase indicator per frequency exceeds a first threshold.

3. The method as claimed in claim 2, wherein, if the phase indicator per frame is less than a second threshold the first downmixing mode is applied to the current frame, and if the phase indicator per frame is greater than the second threshold the second downmixing mode is applied to the current frame.

4. The method as claimed claim 1, wherein an indicator of a time difference between the channels is determined per frame of the stereophonic signal, a third downmixing operation being implemented in the case where the indicator of the time difference is above a threshold.

5. The method as claimed in claim 1, wherein an indicator of a time difference between the channels is determined per frame of the stereophonic signal and wherein, in the case where the indicator of the time difference is less than a threshold, the phase indicator per frame is compared with the second threshold in order to determine whether to apply a first or a second downmixing operation to this frame.

6. The method as claimed in claim 1, wherein the determined phase difference between the channels of the stereophonic signal is smoothed over time via a forgetting factor.

7. The method as claimed in claim 1, wherein the downmixing operation corresponds to filtering of the channels with filters, the method comprising a preliminary phase of defining the filters before application to the stereophonic signal, by using at least one truncating and windowing operation.

8. The method as claimed in claim 7, wherein the preliminary phase of defining the filters comprises the following adapting steps:
obtaining impulse responses of the filters corresponding to the downmixing operation;
truncating part of the impulse responses;
weighting a remaining part of the impulse responses by applying a weighting window;
normalizing the impulse responses resulting applying the weighting window to obtain the adapted filters which are to be applied to a stereophonic signal frame.

9. The method as claimed in claim 8, wherein from one frame to a next the operation of downmixing with adapted filters is applied with a cross-fade step taking into account the impulse responses of the filters used for the frame preceding the current frame.

10. A downmixing device comprising;
a processing circuit which is configured to implement a method for downmixing a stereophonic signal in order to obtain a monophonic signal, the method comprising, for a stereophonic-signal frame, selecting between:
a first downmixing mode comprising filtering with rephasing in each channel of the stereophonic signal by an angle defined by half a phase difference determined between the channels of the stereophonic signal, and
a second downmixing mode comprising filtering with rephasing in a single one of the channels of the stereophonic signal by an angle defined by the phase difference determined between the channels of the stereophonic signal,
wherein the selecting between the first downmixing mode and the second downmixing mode is dependent on a value of a phase indicator determined per frame.

11. A non-transitory computer readable storage medium storing a computer program comprising instructions for executing a method for downmixing a stereophonic signal in order to obtain a monophonic signal, when the instructions are executed by at least one processor of a downmixing device, the method comprising, for a stereophonic-signal frame, selecting between:
a first downmixing mode comprising filtering with rephasing in each channel of the stereophonic signal by an angle defined by half a phase difference determined between the channels of the stereophonic signal, and
a second downmixing mode comprising filtering with rephasing in a single one of the channels of the stereophonic signal by an angle defined by the phase difference determined between the channels of the stereophonic signal,
wherein the selecting between the first downmixing mode and the second downmixing mode is dependent on a value of a phase indicator determined per frame.
